(19) United States
(12) Patent Application Publication
(10) Pub. No.: US 2021/0357452 A1
(43) Pub. Date: Nov. 18, 2021

(54) METHOD FOR OBTAINING ONLINE PICTURE-BOOK CONTENT AND SMART SCREEN DEVICE

(71) Applicant: BAIDU ONLINE NETWORK TECHNOLOGY (BEIJING) CO., LTD., Beijing (CN)

(72) Inventors: Xiaocheng DAI, Beijing (CN); Liu LANG, Beijing (CN); Le WANG, Beijing (CN)

(73) Assignee: BAIDU ONLINE NETWORK TECHNOLOGY (BEIJING) CO., LTD.

(21) Appl. No.: 17/130,325

(22) Filed: Dec. 22, 2020

(30) Foreign Application Priority Data
May 13, 2020 (CN) 202010403581.9

(51) Int. Cl. G06F 16/78; G06F 16/58; G06F 16/783; G06K 9/00

(52) U.S. Cl. CPC G06F 16/7867; G06K 9/00744; G06F 16/7837; G06F 16/5866

(57) ABSTRACT

The present disclosure provides a method for obtaining online picture-book content, and relates to a field of online education technologies. The method is applied to the smart screen device. The method includes: establishing a communication link between the smart screen device and a prism component; identifying an offline picture book by using the prism component and obtaining image content of the offline picture book; and obtaining online picture-book content in a video form based on the image content.

### CROSS-REFERENCE TO RELATED APPLICATION

This application is based upon and claims priority to and benefits of Chinese Patent Application Serial No. 202010403581.9, filed the State Intellectual Property Office of P. R. China on May 13, 2020, the entire content of which is incorporated herein by reference.

### TECHNICAL FIELD

The present disclosure relates to an Internet technical field, especially a field of online education technologies, and more particular to, a method for obtaining online picture-book content and a smart screen device.

### BACKGROUND

Multi-modal intelligent interaction is a main form of intelligent interaction in the future. With development of artificial intelligence technologies, interactions between human and intelligent device/machine tend to be more intelligent and natural. For example, for smart speakers and smart robots, users may obtain various resources through interactions with smart devices, such as in-class educational resources, extra-curricular resources and entertainment resources.

### SUMMARY

Embodiments of the present disclosure provide a method for obtaining online picture-book content, which is applied to a smart screen device. The method includes: establishing a communication link between the smart screen device and a prism component; identifying an offline picture book by using the prism component and obtaining image content of the offline picture book; and obtaining online picture-book content in a video form based on the image content.

Embodiments of the present disclosure provide a smart screen device. The smart screen device includes at least one processor, and a memory communicatively connected to the at least one processor. The memory stores instructions executable by the at least one processor, and when the instructions are executed by the at least one processor, the at least one processor is caused to implement the method for obtaining online picture-book content according to the first aspect of the embodiments of the present disclosure.

Embodiments of the present disclosure provide a non-transitory computer-readable storage medium storing computer instructions. When the instructions are executed, the computer is caused to implement the method for obtaining online picture-book content according to the first aspect of the embodiments of the present disclosure.

It should be understood that the content described in this section is not intended to identify the key or important features of the embodiments of the present disclosure, nor is it intended to limit the scope of the present disclosure. Additional features of the present disclosure will be easily understood by the following description.

### BRIEF DESCRIPTION OF THE DRAWINGS

The drawings are used to better understand the solution and do not constitute a limitation to the present disclosure, in which:

FIG. 1 is a flowchart of a method for obtaining online picture-book content according to Embodiment 1 of the present disclosure.

FIG. 2 is an example diagram of obtaining online picture-book content according to an embodiment of the present disclosure.

FIG. 3 is a flowchart of a method for obtaining online picture-book content according to Embodiment 2 of the present disclosure.

FIG. 4 is a flowchart of a method for obtaining online picture-book content according to Embodiment 3 of the present disclosure.

FIG. 5 is a schematic diagram of an apparatus for obtaining online picture-book content according to Embodiment 4 of the present disclosure.

FIG. 6 is a block diagram of a smart screen device used to implement the method for obtaining online picture-book content according to an embodiment of the present disclosure.

### DETAILED DESCRIPTION

The following describes the exemplary embodiments of the present disclosure with reference to the accompanying drawings, which includes various details of the embodiments of the present disclosure to facilitate understanding, which shall be considered merely exemplary. Therefore, those of ordinary skill in the art should recognize that various changes and modifications can be made to the embodiments described herein without departing from the scope and spirit of the present disclosure. For clarity and conciseness, descriptions of well-known functions and structures are omitted in the following description.

Multi-modal intelligent interaction is a main form of intelligent interaction in the future. With development of artificial intelligence technologies, interactions between human and intelligent device/machine tend to be more intelligent and natural. For example, for smart speakers and smart robots, users may obtain various resources through interactions with smart devices, such as in-class educational resources, extra-curricular resources and entertainment resources.

However, when existing smart devices provide the users with online picture-book content, only content in the audio form is available, thus online picture-book content of various scenarios may not be displayed in a rich multimedia form.

A method and an apparatus for obtaining online picture-book content, a smart screen device and a storage medium according to the embodiments of the present disclosure are described with reference to the accompany drawings.

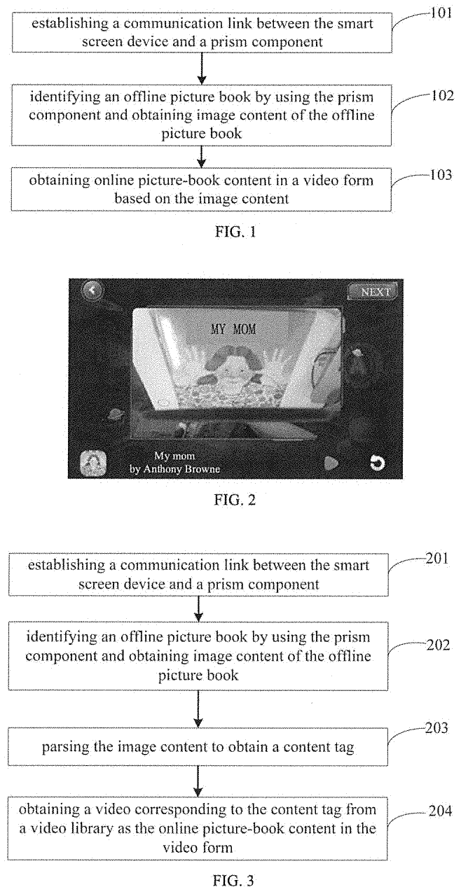

FIG. 1 is a flowchart of a method for obtaining online picture-book content according to Embodiment 1 of the present disclosure.

In the embodiments of the present disclosure, for example, the method for obtaining online picture-book content is configured in an apparatus for obtaining online picture-book content, the apparatus can be applied to any smart screen device, so that the smart screen device could perform the function of obtaining online picture-book content.

In a possible implementation, the method for obtaining online picture-book content according to the embodiments of the present disclosure may be applied to an educational application (APP), and the educational APP may be run on a smart screen device. The smart screen device may be a smart device with a touch screen.

It should be noted that, in order to make it easy for a child to read a picture book, a large touch screen may be arranged on the smart device and inclined to a certain angle. For example, the screen of the smart screen device may be 8 inches, and a tilt angle of the screen may be 105°.

As illustrated in FIG. 1, the method for obtaining online picture-book content may include the following actions.

At block 101, a communication link between the smart screen device and a prism component is established.

The smart screen device may implement far-field voice interaction and multi-modal interactions with a user such as gesture control, eyes awakening and face recognition, so as to bring the user a natural and diversified human-computer interaction experience. For example, the smart screen device may be a smart speaker equipped with a touch screen.

It is understood that, when the smart screen device is in a sleep state, the user may wake up the smart screen device through voice, face recognition, a touch, and a click, so that the smart screen device in an awake state may establish a communication link with the prism component.

The prism component in embodiments of the present disclosure may include a prism framework or a reflector.

In some embodiments of the present disclosure, the smart screen device may establish a communication link with the prism component through a Universal Serial Bus (USB) interface, and may also establish a communication link with the prism component through Bluetooth, or wireless communication network connection.

It should be noted that, the communication connection mode between the smart screen device and the prism component is not limited to the above-mentioned communication connection modes, and the communication link can also be established through other communication connection modes, which is not limited herein.

At block 102, an offline picture book is identified by using the prism component and image content of the offline picture book is obtained.

The offline picture book may be a children's picture book or an adult picture book, which is not limited herein.

In an embodiment of the present disclosure, after the communication link between the smart screen device and the prism component is established, the offline picture book may be identified by using the prism component to obtain the image content of the offline picture book. The image content of the offline picture book may be image content of a cover of the offline picture book, or may be image content of a body part of the offline picture book, which is not limited herein. The image content of the offline picture book may also include an image portion and/or a text portion.

For example, since image contents of covers of respective offline picture books are different, when the image content of the offline picture book is the image content of the cover of the offline picture book, the smart screen device may effectively recognize and obtain the image content of the cover of the offline picture book, to obtain online picture-book content in a video form that matches the image content of the cover. In an embodiment of the present disclosure, the smart screen device may detect the image content of the offline picture book in an offline or online state, which is not limited herein.

In a possible implementation, the prism component may be arranged on the top of the smart screen device. The offline picture book and the smart screen device may be placed on the same level, and the offline picture book is recognized by the prism component to make the smart screen device obtain the image content of the offline picture book.

For example, a camera is provided in the prism component, the camera in the prism component is used to collect images corresponding to the offline picture book, and then the collected images are identified to obtain the image content of the offline picture book.

In an embodiment of the present disclosure, after the camera in the prism component acquires the images of the offline picture book, image recognition is performed on the collected images of the offline picture book to obtain the image content of the offline picture book.

For example, after the camera collects the images of the offline picture book, image enhancement may be performed on the images collected to reduce noises in the images and improve definition and quality of the images. Moreover, image processing is performed by encoding and compressing the images. Then, feature extraction is performed on the images obtained by the image processing, so that, an extracted feature map is inputted into a trained image recognition model to determine the image content of the offline picture book according to an output of the model.

It should be noted that, other image recognition methods may also be used to process the images of the offline picture book collected by the camera, such as an image recognition method based on neural networks, an image recognition method based on wavelet invariant moments, to obtain initial picture book content including the image content.

It is understood that, when the prism component is used to identify the offline picture book to obtain the image content corresponding to the offline picture book, not only the cover of the offline picture book may be recognized, but also the body part of the offline picture book may also be recognized, which is not limited herein.

For example, as illustrated in FIG. 2, the smart screen device in FIG. 2 may be a smart speaker, and the smart speaker may be placed on the same level as the offline picture book, so that a prism component arranged on the top of the smart speaker may identify the offline picture book to obtain the image content corresponding to the offline picture book. In a possible implementation, when the smart speaker does not recognize a valid offline picture book, and the smart speaker may prompt the user to change to another offline picture book.

For example, a text, such as “the picture book is invalid, please change to another book”, may be displayed on the screen of the smart speaker to prompt the user. Alternatively, a speech, such as “the picture book is invalid, please change to another book”, may be played to prompt the user. Moreover, a specific sound may be made to remind the user, such as playing buzzing or a preset music, which is not limited herein.

In another possible implementation, after the offline picture book is captured by a prism of the prism component, the offline picture book captured by the prism may be collected by the camera arrange on the smart screen device, so that after the smart screen device obtains the images of the offline picture book, and the content of the offline picture book is identified to obtain the image content of the offline picture book.

In a possible implementation according to an embodiment of the present disclosure, a structured light emitting device may be installed on the smart screen device. The structured light emitting device is used to emit structured lights to the offline picture book. After the structured lights are illuminated to the offline picture book, the image content of the offline picture book may be obtained according to distortion of the structured lights caused by the reflected structured lights reflected by the offline picture book.

For example, the types of structured light may include a grating type, a light-spot type, and a speckle type (including a circular speckle and a cross speckle), and all of the above-mentioned types of structured light are uniformly arranged. Correspondingly, a device for generating the structured lights may be a certain type of projecting device or instrument that may project light spots, lines, gratings, grids or speckles onto the offline picture book. For example, the projecting device may be an optical projector, or a laser for generating laser beams.

At block 103, online picture-book content in a video form is obtained based on the image content.

The online picture-book content may be content stored in a picture-book content library obtained in advance by the smart screen device, or may be online picture-book content provided by a third-party APP, or online picture-book content queried and obtained by an external search engine and fed back to an educational APP, which is not limited herein.

In some embodiments of the present disclosure, after the image content of the offline picture book is obtained, the online picture-book content in the video form may be obtained based on the image content.

As a possible implementation, the online picture-book content in the video form that matches the image content may be obtained according to the image portion and the text portion included in the image content from the picture-book content library acquired in advance by the smart screen device.

As another possible implementation, the online picture-book content in the video form that matches the image content may also be obtained from the third-party APP according to the image portion and the text portion included in the image content.

As yet another a possible implementation, the online picture-book content in the video form that matches the image content may be queried by an external searching engine according to the image portion and the text portion included in the image content.

It should be noted that, the online picture-book content obtained based on the image content may be video content synchronized with the content of the offline picture book, so that the online picture-book content may be displayed in the video form on a display page of the smart screen device, to provide the content of the offline picture book to the user in a lively and vivid way.

In an embodiment of the present disclosure, after the smart screen device obtains the online picture-book content in the video form, the online picture-book content may be presented in the video form on a main interface of the educational APP installed on the smart screen device, so that the user may obtain the online picture-book content in the video form.

The method for obtaining online picture-book content is applied to the smart screen device. The communication link between the smart screen device and the prism component is established. The offline picture book is identified by using the prism component to obtain the image content of the offline picture book. The online picture-book content in the video form is obtained based on the image content. With this method, the image content of the offline picture book is obtained and identified by the prism component having the communication link with the smart screen device, so that the online picture-book content in the video form is obtained according to the image content. Compared to only obtaining the online picture-book content in an audio form in the related art, the present disclosure realizes the display of online picture-book content in the video form on the smart screen device, which may provide the offline picture-book content to a user in a vivid and lively way.

On the basis of the above embodiments, the present disclosure provides another method for obtaining online picture-book content.

FIG. 3 is a flowchart of a method for obtaining online picture-book content according to Embodiment 2 of the present disclosure.

As illustrated in FIG. 3, the method for obtaining the online picture-book content includes the following actions.

At block 201, a communication link between the smart screen device and a prism component is established.

At block 202, an offline picture book is identified by using the prism component and image content of the offline picture book is obtained.

In some embodiments of the present disclosure, the implementation process of actions at blocks 201 and 202 may refer to the implementation process of actions at blocks 101 and 102 in the above embodiments, which will not be repeated herein.

At block 203, the image content is parsed to obtain a content tag.

The content tag is labeled based on the image content of the offline picture book, which is used to obtain the online picture-book content in a video form.

In an embodiment, the image content of a large number of offline picture books may be labeled in advance to generate a content tag of image content of each offline picture book. For example, a cover of an offline picture book may be labeled, and content of each page of the offline picture book may be labeled. When the image content of the offline picture book is labeled, images of the offline picture book may be collected through a camera at different angles and positions, so that the content tags corresponding to the images are obtained by labeling the image content corresponding to the images.

As a possible implementation, the image content of the offline picture book may be input into a pre-trained content recognition model to obtain the content tag according to an output of the model.

The content recognition model may be a model based on a deep neural network. The content recognition model may be pre-trained based on labelled image content corresponding to a large number of offline picture books, and the correspondence relation between the image content and each content tag is learned by the content recognition model.

At block 204, a video corresponding to the content tag is obtained from a video library as the online picture-book content in the video form.

The video, all called as a picture-book video, may be picture-book content displayed in a video form. The video library may store picture-book videos labeled with content tags in advance based on content tags corresponding to image content of a large number of offline picture books.

In an embodiment of the present disclosure, after the image content of the offline picture book is parsed to obtain the content tag of the image content, the picture-book video corresponding to the content tag may be obtained from the video library as the online picture-book content in the video form.

As a possible implementation, the smart screen device may store a plurality of picture-book videos in a local video library in advance, so that the picture-book video corresponding to the content tag may be obtained from the local video library of the smart screen device based on the content tag obtained by parsing the image content. Thus, the obtained picture-book video is determined as the online picture-book content in the video form. Therefore, by providing the picture-book videos based on the local video library of the smart screen device, the speed of obtaining the online picture-book content in the video form is improved, which is conducive to improving the user experience of obtaining the online picture-book content.

As another possible implementation, in a case that the picture-book video corresponding to the content tag is not obtained from the local video library of the smart screen device based on the content tag obtained by parsing the image content, the picture-book video corresponding to the content tag may be obtained from a third-party video library, so as to determine the obtained picture-book video as the online picture-book content in the video form. Thereby, it is realized that when the picture-book video corresponding to the content tag is not stored in the local video library, the corresponding picture-book video may also be obtained.

As another possible implementation, after obtaining the content tag by parsing the image content of the offline picture book, the picture-book videos corresponding to the content tag may be simultaneously obtained from both the local video library and the third-party video library. When the obtained picture book videos are different, the latest version of the picture-book video is determined as the online picture-book content in the video form to display on the screen of the smart screen device. Alternatively, the different picture-book videos may be displayed on the screen of the smart screen device for the user to choose a picture-book video to be displayed.

In an embodiment, the video library may include candidate content tags, and candidate videos corresponding to the candidate content tags respectively. That is, a plurality of content tags and picture-book videos corresponding to the content tags may be stored in the video library.

In an embodiment of the present disclosure, after the content tag is obtained by parsing the image content of the offline picture book, a candidate video corresponding to a candidate content tag matching the content tag may be obtained from the video library as the online picture-book content in the video form. Therefore, the efficiency of obtaining the online picture-book content in the video form is improved.

It is understood that, after the content tag is obtained by parsing the image content of the offline picture book, the content tag may be compared with the candidate content tags stored in the video library. When it is determined that the content tag matches a certain candidate content tag, the candidate video corresponding to the candidate content tag matching the content tag obtained from the video library may be determined as the online picture-book content in the video form.

For example, it may be determined whether there is a candidate content tag that matches the content tag of the offline picture book in the candidate content tags stored in the local video library. When there is a candidate content tag matching the content tag of the offline picture book in the candidate content tags stored in the local video library, a candidate video corresponding to the candidate content tag matching the content tag may be directly obtained from the local video library as the online picture-book content in the video form. Moreover, if there is no candidate content tag matching the content tag of the offline picture book in the candidate content tags stored in the local video library, the picture-book video corresponding to the content tag may be obtained from the third-party video library.

In an embodiment, after the smart screen device obtains the online picture-book content in the video form, the online picture-book content may be presented in the video form on a main interface of an educational APP installed on the smart screen device, so that the user may obtain the online picture-book content in the video form.

The method for obtaining online picture-book content is applied to the smart screen device. The communication link between the smart screen device and the prism component is established. The offline picture book is identified by using the prism component to obtain image content of the offline picture book. The image content is parsed to obtain the content tag. The video corresponding to the content tag is obtained from the video library as the online picture-book content in the video form. Therefore, the corresponding content tag is obtained by parsing the image content of the offline picture book to obtain the online picture-book content in the video form from the video library, so as to achieve the purpose of displaying the online picture-book content in the video mode, and provide the online picture-book content to the user in a lively and vivid way.

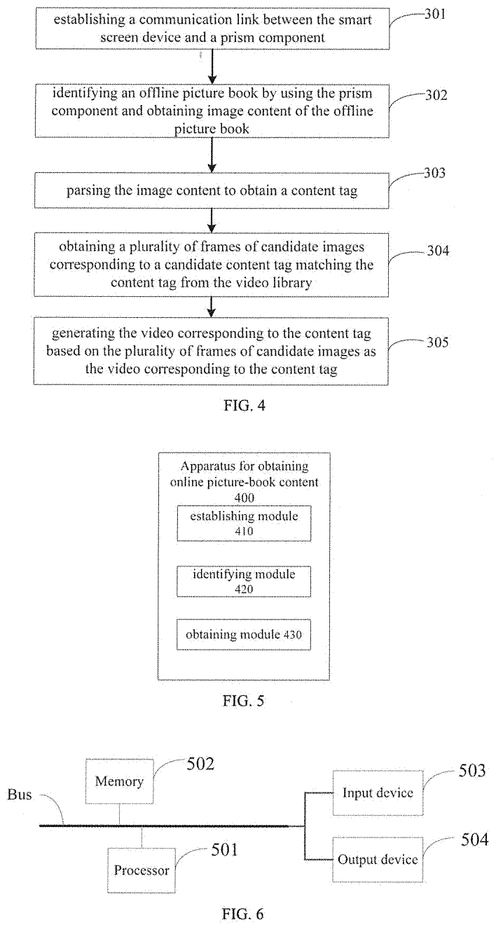

Based on the above embodiments, in a possible implementation, the video library may include candidate content tags and a plurality of frames of candidate picture-book images corresponding to each candidate content tag. In this case, a plurality of frames of candidate picture-book images corresponding to a candidate content tag matching the content tag are obtained from the video library, a picture-book video corresponding to the content tag is generated based on the plurality of frames of candidate images obtained. The above process is described in detail below with reference to FIG. 4, FIG. 4 is a flowchart of a method for obtaining online picture-book content according to Embodiment 3 of the present disclosure.

As illustrated in FIG. 4, the method for obtaining online picture-book content includes the following actions.

At block 301, a communication link between a smart screen device and a prism component is established.

At block 302, an offline picture book is identified by using the prism component and image content of the offline picture book is obtained.

At block 303, the image content is parsed to obtain a content tag.

In some embodiments of the present disclosure, implementation process of actions at block 301 to 303 may refer to the implementation process of actions at block 201 to 203 in the above embodiments, which will not be repeated herein.

At block 304, a plurality of frames of candidate images corresponding to a candidate content tag matching the content tag are obtained from the video library as the video corresponding to the content tag.

In an embodiment, the video library may include candidate content tags, and a plurality of frames of candidate images corresponding to each candidate content tag. In other words, a plurality of content tags and a plurality of frames of picture-book images corresponding to each content tag may be stored in the video library. For example, an offline picture book has 5 pages, and the video library may store 5 frames of picture-book images corresponding to the offline picture book.

It is understood that, a complete offline picture book may include a plurality of pieces of content, so the content tag of the image content of the offline picture book may correspond to the plurality of frames of candidate images.

In an embodiment of this disclosure, after parsing the image content of the offline picture book and obtaining the content tag corresponding to the image content, the content tag corresponding to the image content may be compared with the candidate content tags stored in the video library to obtain a candidate content tag matching the content tag corresponding to the image content from the video library. Further, the plurality of frames of candidate picture-book images matching the candidate content tag matching the content tag are obtained from the video library.

It should be noted that, the video library of the present disclosure may be a local video library corresponding to the smart screen device, or a third-party video library, which is not limited here.

It is understood that, in order to improve the speed of obtaining the online picture-book content in the video form corresponding to the offline picture book, it may be firstly determined whether the local video library has a candidate content tag that matches the content tag corresponding to the image content of the offline picture book stored thereon. In a possible situation, when it is determined that there is a candidate content tag matching the content tag stored in the local video library, the plurality of frames of candidate images corresponding to the candidate content tag matching the content tag are directly obtained from the video library.

In another possible situation, when it is determined that there is no candidate content tag matching the content tag in the local video library, and when it is determined that there is a candidate content tag matching the content tag in the third-party video library, the plurality of frames of candidate picture-book images corresponding to the candidate content tag matching the content tag are directly obtained from the third-party video library.

At block 305, the video corresponding to the content tag is generated based on the plurality of frames of candidate images obtained as the online picture-book content in the video form.

In the embodiments of the present disclosure, after obtaining the plurality of frames of candidate images corresponding to the candidate content tag matching the content tag from the video library, the video corresponding to the content tag is generated based on the plurality of frames of candidate images obtained to further obtain the online picture-book content in the video form.

In a possible situation, each frame of candidate image corresponds to a timestamp. That is, each frame of candidate image carries one timestamp. In an embodiment of the present disclosure, the video corresponding to the content tag may be generated based on the plurality of frames of candidate images obtained and the timestamp corresponding to each of the plurality of frames of candidate images obtained as the online picture-book content in the video form.

For example, the plurality of frames of candidate images may be sorted according to an order of the timestamp corresponding to each frame of candidate image, so as to generate the corresponding video based on the plurality of frames of candidate images sorted.

In an embodiment of the present disclosure, each frame of candidate image corresponds to a piece of text content, and after generating the video corresponding to the content tag based on the plurality of candidate image frames obtained, an audio corresponding to the video corresponding to the content tag may be generated based on the text content corresponding to each frame of candidate image, and the video is associated with the audio.

With the method for obtaining online picture-book content, the communication link between the smart screen device and the prism component is established. The offline picture book is identified by using the prism component and the image content of the offline picture book is obtained. The image content is parsed to obtain the content tag. The plurality of frames of candidate images corresponding to the candidate content tag matching the content tag are obtained from the video library. The video corresponding to the content tag is generated based on the plurality of frames of candidate images obtained as the online picture-book content in the video form. In this way, the plurality of frames of candidate images corresponding to the content tag may be obtained from the video library to generate the video, thereby achieving the acquisition of the online picture-book content in the video form.

In any of the above embodiments, as a possible situation, the prism component includes a camera component and an image identifying component. The camera component is configured to obtain a picture-book image of the offline picture book in a multi-modal interactive manner. The image identifying component is configured to identify an image characteristic of the picture-book image of the offline picture book.

Each source or form of information may be called a modality. For example, each of senses of a person such as touch, hearing, sight, and smell, mediums of information including a speech, a video and a text, various sensors, such as radar, infrared and accelerometer, may be called a modality.

Two different languages may be considered as two modalities, or even data sets collected under two different situations may also be considered as two modalities. Therefore, in the present disclosure, the image content of the offline picture book may be captured in a multi-modal interactive manner.

As a possible implementation, when obtaining the online picture-book content, the prism component may be installed on the top of the smart screen device, and the smart screen device and the offline picture book are on the same level. Thus, the camera component in the prism component may capture images of the offline picture book. After obtaining the images of the offline picture book collected by the camera component, the image identifying component may perform image recognition on the picture-book images to identify the image characteristics of the picture-book images. Further, the processor of the smart screen device may parse the image characteristics of the picture-book images to obtain the image content of the offline picture book.

It should be noted that, the camera component may be provided with a normal camera, and the normal camera may be used to capture offline textbook content to obtain a two-dimensional picture-book image corresponding to the offline textbook content. The camera component may also be provided with a depth camera, and the depth camera is used to capture the content of the offline picture book to obtain a three-dimensional picture-book image containing depth information. Certainly, the camera component may be provided with other forms of cameras, which are not limited here.

In an embodiment of the present disclosure, after the processor of the smart screen device obtains the image characteristics of the picture-book images, the image characteristics are input into the trained image recognition model to determine the image content of the offline picture book according to the output of the model.

Thus, the image characteristics of the offline picture book may be obtained through the prism component, and the image content of the offline picture book is obtained by parsing, so as to obtain the online picture-book content in the video form according to the image content, thus realizing the display of the online picture-book content in the video form on the smart screen device, which may cultivate good reading habits of children. By reading picture books by flipping, watching, listening and thinking, children are immersed in the wonderful the picture book content, thus language skills, emotional experience and thinking ability are promoted.

In order to implement the above embodiments, the present disclosure provides an apparatus for obtaining online picture-book content.

FIG. 5 is a schematic diagram of an apparatus for obtaining online picture-book content according to Embodiment 4 of the present disclosure.

As illustrated in FIG. 5, the apparatus for obtaining online picture-book content 400 is applied to a smart screen device. The apparatus for obtaining online picture-book content 400 includes: an establishing module 410, an identifying module 420 and an obtaining module 430. The establishing module 410 is configured to establish a communication link between the smart screen device and a prism component. The identifying module 420 is configured to identify an offline picture book by using the prism component and obtain image content of the offline picture book. The obtaining module 430 is configured to obtain online picture-book content in a video form based on the image content.

In a possible situation, the obtaining module 430 includes: a parsing unit and an obtaining unit.

The parsing unit is configured to parse the image content to obtain a content tag.

The obtaining unit is configured to obtain a video corresponding to the content tag from a video library as the online picture-book content in the video form.

In another possible situation, the obtaining unit is configured to: obtain the video corresponding to the content tag from a local video library; and/or, obtain the video corresponding to the content tag from a third-party video library.

In another possible situation, video library includes candidate content tags and candidate videos corresponding to the candidate content tags respectively, and the obtaining unit is further configured to obtain a candidate video corresponding to a candidate content tag matching the content tag from the video library as the video corresponding to the content tag.

In another possible situation, the video library includes candidate content tags and a plurality of frames of candidate images corresponding to each candidate content tag, and the obtaining unit is further configured to: obtain a plurality of frames of candidate images corresponding to a candidate content tag matching the content tag from the video library as the video corresponding to the content tag; and generate the video corresponding to the content tag based on the plurality of frames of candidate images obtained.

In another possible situation, each frame of candidate image corresponds to a timestamp, and the obtaining unit is further configured to: generate the video corresponding to the content tag based on the plurality of frames of candidate images obtained and the timestamp corresponding to the plurality of frames of candidate images obtained.

In another possible situation, each frame of candidate image corresponds to a piece of text content, and the obtaining unit is further configured to: generate an audio corresponding to the video corresponding to the content tag based on the text content corresponding to each frame of candidate image, and store the video in association with the audio.

In another possible situation, the prism component includes a camera component and an image identifying component, in which a picture-book image of the offline picture book is captured in a multi-modal interactive manner by the camera component; an image characteristic of the picture-book image of the offline picture book is identified by the image identifying component; and the image characteristic is parsed to obtain the image content by a processor of the smart screen device.

In another possible situation, the image content includes image content of a cover of the offline picture book.

In another possible situation, the apparatus for obtaining online picture-book content 400 further includes: a displaying module, configured to present the online picture-book content in the video form on a main interface of an education application program.

The apparatus for obtaining online picture-book content is applied to the smart screen device. The communication link between the smart screen device and the prism component is established. The offline picture book is identified by using the prism component to obtain image content of the offline picture book. The online picture-book content in a video form is obtained based on the image content. This method obtains the image content of the offline picture book through the recognition of the prism component having the communication link with the smart screen device, so as to obtain the online picture-book content in the video form according to the image content. Compared to the related art, only the online picture-book content in the audio form is obtained. This disclosure realizes the display of the online picture-book content in the video form on the smart screen device, so as to provide the offline picture-book content to users in a vivid way.

According to the embodiments of the present disclosure, the present disclosure also provides an electronic device and a readable storage medium.

FIG. 6 is a block diagram of a smart screen device used to implement the method for obtaining online picture-book content according to an embodiment of the present disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the present disclosure described and/or required herein.

As illustrated in FIG. 6, the electronic device includes: one or more processors 501, a memory 502, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 501 is taken as an example in FIG. 6.

The memory 502 is a non-transitory computer-readable storage medium according to the present disclosure. The memory stores instructions executable by at least one processor, so that the at least one processor executes the method according to the present disclosure. The non-transitory computer-readable storage medium of the present disclosure stores computer instructions, which are used to cause a computer to execute the method according to the present disclosure.

As a non-transitory computer-readable storage medium, the memory 502 is configured to store non-transitory software programs, non-transitory computer executable programs and modules, such as program instructions/modules (for example, the establishing module 410, the identifying module 420, and the obtaining module 430 shown in FIG. 5) corresponding to the method in the embodiment of the present disclosure. The processor 501 executes various functional applications and data processing of the server by running non-transitory software programs, instructions, and modules stored in the memory 502, that is, implementing the method in the foregoing method embodiments.

The memory 502 may include a storage program area and a storage data area, where the storage program area may store an operating system and application programs required for at least one function. The storage data area may store data created according to the use of the electronic device for implementing the method. In addition, the memory 502 may include a high-speed random access memory, and a non-transitory memory, such as at least one magnetic disk storage device, a flash memory device, or other non-transitory solid-state storage device. In some embodiments, the memory 502 may optionally include a memory remotely disposed with respect to the processor 501, and these remote memories may be connected to the electronic device for implementing the method through a network. Examples of the above network include, but are not limited to, the Internet, an intranet, a local area network, a mobile communication network, and combinations thereof.

The electronic device for implementing the method may further include: an input device 503 and an output device 504. The processor 501, the memory 502, the input device 503, and the output device 504 may be connected through a bus or in other manners. In FIG. 6, the connection through the bus is taken as an example.

The input device 503 may receive inputted numeric or character information, and generate key signal inputs related to user settings and function control of an electronic device for implementing the method, such as a touch screen, a keypad, a mouse, a trackpad, a touchpad, an indication rod, one or more mouse buttons, trackballs, joysticks and other input devices. The output device 504 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, sound input, or tactile input).

The systems and technologies described herein can be implemented in a computing system that includes background components (for example, a data server), or a computing system that includes middleware components (for example, an application server), or a computing system that includes front-end components (For example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other.

The method for obtaining online picture-book content is applied to the smart screen device. The communication link between the smart screen device and the prism component is established. The offline picture book is identified by using the prism component to obtain image content of the offline picture book. The online picture-book content in a video form is obtained based on the image content. This method obtains the image content of the offline picture book through the recognition of the prism component having the communication link with the smart screen device, so as to obtain the online picture-book content in the video form according to the image content. Compared to the related art, only the online picture-book content in the audio form is obtained. This disclosure realizes the display of the online picture-book content in the video form on the smart screen device, so as to provide the offline picture-book content to users in a vivid way.

It should be understood that the various forms of processes shown above can be used to reorder, add or delete steps. For example, the steps described in the present disclosure may be performed in parallel, sequentially, or in a different order, as long as the desired result of the technical solution disclosed in the present disclosure is achieved, which is not limited herein.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

1. A method for obtaining online picture-book content, applied to a smart screen device, comprising:
establishing a communication link between the smart screen device and a prism component;
identifying an offline picture book by using the prism component and obtaining image content of the offline picture book; and
obtaining online picture-book content in a video form based on the image content.

2. The method according to claim 1, wherein obtaining the online picture-book content in the video form based on the image content comprises:
parsing the image content to obtain a content tag; and
obtaining a video corresponding to the content tag from a video library as the online picture-book content in the video form.

3. The method according to claim 2, wherein obtaining the video corresponding to the content tag from the video library comprises:
obtaining the video corresponding to the content tag from a local video library; and/or,
obtaining the video corresponding to the content tag from a third-party video library.

4. The method according to claim 2, wherein video library comprises candidate content tags and candidate videos corresponding to the candidate content tags respectively, and obtaining the video corresponding to the content tag from the video library comprises:
obtaining a candidate video corresponding to a candidate content tag matching the content tag from the video library as the video corresponding to the content tag.

5. The method according to claim 2, wherein the video library comprises candidate content tags and a plurality of frames of candidate images corresponding to each candidate content tag, and obtaining the video corresponding to the content tag from the video library comprises:
obtaining a plurality of frames of candidate images corresponding to a candidate content tag matching the content tag from the video library as the video corresponding to the content tag; and
generating the video corresponding to the content tag based on the plurality of frames of candidate images obtained.

6. The method according to claim 5, wherein each frame of candidate image corresponds to a timestamp, and generating the video corresponding to the content tag based on the plurality of frames of candidate images obtained comprises:
generating the video corresponding to the content tag based on the plurality of frames of candidate images obtained and the timestamps corresponding to the plurality of frames of candidate images obtained.

7. The method according to claim 5, wherein each frame of candidate image corresponds to a piece of text content, and after generating the video corresponding to the content tag based on the plurality of candidate image frames obtained, the method further comprises:
generating an audio corresponding to the video corresponding to the content tag based on the text content corresponding to each frame of candidate image, and storing the video in association with the audio.

8. The method according to claim 1, wherein the prism component comprises a camera component and an image identifying component, and obtaining the image content of the offline picture book by identifying the offline picture book by using the prism component comprises:
capturing, by the camera component, a picture-book image of the offline picture book in a multi-modal interactive manner;
identifying, by the image identifying component, an image characteristic of the picture-book image of the offline picture book; and,
parsing the image characteristic to obtain the image content by a processor of the smart screen device.

9. The method according to claim 1, wherein the image content comprises image content of a cover of the offline picture book.

10. The method according to claim 1, further comprising:
presenting the online picture-book content in the video form on a main interface of an education application program.

11. A smart screen device, comprising:
at least one processor; and
a memory communicatively connected to the at least one processor; wherein,
the memory stores instructions executable by the at least one processor, and when the instructions are executed by the at least one processor, the at least one processor is caused to implement a method for obtaining online picture-book content, the method comprising:
establishing a communication link between the smart screen device and a prism component;
identifying an offline picture book by using the prism component and obtaining image content of the offline picture book; and
obtaining online picture-book content in a video form based on the image content.

12. The smart screen device according to claim 11, wherein obtaining the online picture-book content in the video form based on the image content comprises:
parsing the image content to obtain a content tag; and
obtaining a video corresponding to the content tag from a video library as the online picture-book content in the video form.

13. The smart screen device according to claim 12, wherein obtaining the video corresponding to the content tag from the video library comprises:
obtaining the video corresponding to the content tag from a local video library; and/or,
obtaining the video corresponding to the content tag from a third-party video library.

14. The smart screen device according to claim 12, wherein video library comprises candidate content tags and candidate videos corresponding to the candidate content tags respectively, and obtaining the video corresponding to the content tag from the video library comprises:
obtaining a candidate video corresponding to a candidate content tag matching the content tag from the video library as the video corresponding to the content tag.

15. The smart screen device according to claim 12, wherein the video library comprises candidate content tags and a plurality of frames of candidate images corresponding to each candidate content tag, and obtaining the video corresponding to the content tag from the video library comprises:
obtaining a plurality of frames of candidate images corresponding to a candidate content tag matching the content tag from the video library as the video corresponding to the content tag; and
generating the video corresponding to the content tag based on the plurality of frames of candidate images obtained.

16. The smart screen device according to claim 15, wherein each frame of candidate image corresponds to a timestamp, and generating the video corresponding to the content tag based on the plurality of frames of candidate images obtained comprises:
generating the video corresponding to the content tag based on the plurality of frames of candidate images obtained and the timestamps corresponding to the plurality of frames of candidate images obtained.

17. The smart screen device according to claim 15, wherein each frame of candidate image corresponds to a piece of text content, and after generating the video corresponding to the content tag based on the plurality of candidate image frames obtained, the method further comprises:
generating an audio corresponding to the video corresponding to the content tag based on the text content corresponding to each frame of candidate image, and storing the video in association with the audio.

18. The smart screen device according to claim 11, wherein the prism component comprises a camera component and an image identifying component, and obtaining the image content of the offline picture book by identifying the offline picture book by using the prism component comprises:
capturing, by the camera component, a picture-book image of the offline picture book in a multi-modal interactive manner;
identifying, by the image identifying component, an image characteristic of the picture-book image of the offline picture book; and,
parsing the image characteristic to obtain the image content by a processor of the smart screen device.

19. The smart screen device according to claim 11, wherein the image content comprises image content of a cover of the offline picture book.

20. A non-transitory computer-readable storage medium storing computer instructions, wherein the computer instructions are used to cause the computer to implement a method for obtaining online picture-book content, the method comprising:
establishing a communication link between the smart screen device and a prism component;
identifying an offline picture book by using the prism component and obtaining image content of the offline picture book; and
obtaining online picture-book content in a video form based on the image content.
